(19) United States
(12) Patent Application Publication
(10) Pub. No.: US 2006/0136984 A1
(43) Pub. Date: Jun. 22, 2006

(54) Data receiving apparatus and method

(75) Inventor: Hideki Ohkita, Kunitachi-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Kabushiki Kaisha Toshiba

(21) Appl. No.: 11/189,003

(22) Filed: Jul. 26, 2005

(30) Foreign Application Priority Data
Dec. 17, 2004 (JP) 2004-366423

(51) Int. Cl. H04N 11/00; H04N 7/08; H04N 7/16; H04N 7/00

(52) U.S. Cl. 725/137; 348/468; 725/136

(57) ABSTRACT

A data receiving apparatus of this invention includes an antenna which receives at least one of broadcast audiovisual data and non-audiovisual data, a data monitoring unit which detects the non-audiovisual data received by the antenna, a related information acquiring unit which acquires information corresponding to predetermined items in accordance with the type of detected non-audiovisual data, a channel assigning unit which assigns an identification number to the non-audiovisual data from which the information is acquired, and a communication unit which notifies a client device for viewing of audiovisual data of the assigned identification number and the information acquired by the related information acquiring unit from the non-audiovisual data assigned the identification number.

### CROSS-REFERENCE TO RELATED APPLICATIONS

This application is based upon and claims the benefit of priority from prior Japanese Patent Application No. 2004-366423, filed Dec. 17, 2004, the entire contents of which are incorporated herein by reference.

### BACKGROUND OF THE INVENTION

1. Field of the Invention

The present invention relates to a data receiving apparatus and method which receive broadcast audiovisual data and non-audiovisual data and output the data to a client device such as a TV set, a PC with a TV viewing function, a video recorder, or a DVD recorder.

2. Description of the Related Art

Currently, along with the digitization of TV broadcasting, data receiving apparatuses which receive broadcast data have become popular. Such a data receiving apparatus is a tuner, which receives data broadcast from a broadcasting station and outputs the data to a connected client device such as a TV set, a PC with a TV function, a video recorder, or a DVD recorder. Note that data received by the data receiving apparatus include not only digital data but also analog data.

In a conventional broadcasting operation using analog data, only audiovisual data for viewing of broadcast programs are broadcast. In contrast, using digital data makes it possible to broadcast not only such audiovisual data but also various data other than audiovisual data (to be referred to as “non-audiovisual data” hereinafter), including setting data for a data receiving apparatus and a client device, application programs, program information data, and data for notification to viewers.

Such non-audiovisual data is assigned a unique number called a channel item. When non-audiovisual data is received by the data receiving apparatus, the data is stored in a tuner container in the data receiving apparatus in association with such a channel item. The data receiving apparatus acquires heading information such as a title from this non-audiovisual data and writes the acquired heading information in a channel item list together with the channel item. With this operation, the heading information of the non-audiovisual data stored in the tuner container and the channel item are listed up in the channel item list.

The client device connected to the data receiving apparatus can distingue the non-audiovisual data stored in the tuner container by referring to the channel items listed up in the channel item list in the data receiving apparatus. If there is any non-audiovisual data which the user wants to acquire, he/she can download the non-audiovisual data stored in the tuner container by designating the corresponding channel item.

For example, Jpn. Pat. Appln. KOKAI Publication No. 2004-56394 discloses a technique of allowing a user to acquire data stored in a data receiving apparatus by issuing a request to the data receiving apparatus.

With this operation, the client device can acquire necessary setting data, adjust self parameters on the basis of the setting data, acquire necessary application programs, install or update the programs, acquire electronic programs, and refer to them.

However, since non-audiovisual data are always broadcast from a broadcasting station to such a conventional data receiving apparatus, the non-audiovisual data stored in the tuner container are rewritten by other non-audiovisual data after a lapse of a predetermined time due to limited capacity of the tuner container.

For this reason, when necessary non-audiovisual data is stored in the tuner container, the user needs to download the data while it is stored, i.e., before it is rewritten by another non-audiovisual data.

The user, however, cannot recognize which kinds of non-audiovisual data are stored in the tuner container unless he/she refers to the channel item list in the data receiving apparatus by operating the client device. Therefore, the user must periodically check the channel item list. Otherwise, necessary non-audiovisual data may be rewritten by another non-audiovisual data before the user knows it.

### BRIEF SUMMARY OF THE INVENTION

According to an embodiment of the present invention, a data receiving apparatus comprises a receiving unit configured to receive at least one of broadcast audiovisual data and non-audiovisual data, a detecting unit configured to detect the non-audiovisual data received by the receiving unit, an acquiring unit configured to acquire information corresponding to a predetermined item from the non-audiovisual data detected by the detecting unit in accordance with a type of the data, an assigning unit configured to assign an identification number to the non-audiovisual data from which the information is acquired by the acquiring unit, and a notifying unit configured to notify a client device for viewing of the audiovisual data of the identification number assigned by the assigning unit and the information acquired by the acquiring unit from the non-audiovisual data assigned with the identification number.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a functional block diagram showing an example of a data receiving apparatus to which a data receiving method according to an embodiment of the present invention is applied;

FIG. 2 is a view showing an example of a related information table generated for an application program;

FIG. 3 is a view showing an example of a related information table generated for setting data;

FIG. 4 is a view showing an example of a related information table generated for program information data;

FIG. 5 is the first half of a flowchart showing an example of the operation of the data receiving apparatus to which the data receiving method according to the embodiment of the present invention is applied; and

FIG. 6 is the second half of the flowchart showing the example of the operation of the data receiving apparatus to which the data receiving method according to the embodiment of the present invention is applied.

### DETAILED DESCRIPTION OF THE INVENTION

The best mode for carrying out the present invention will be described below with reference to the views of the accompanying drawing.

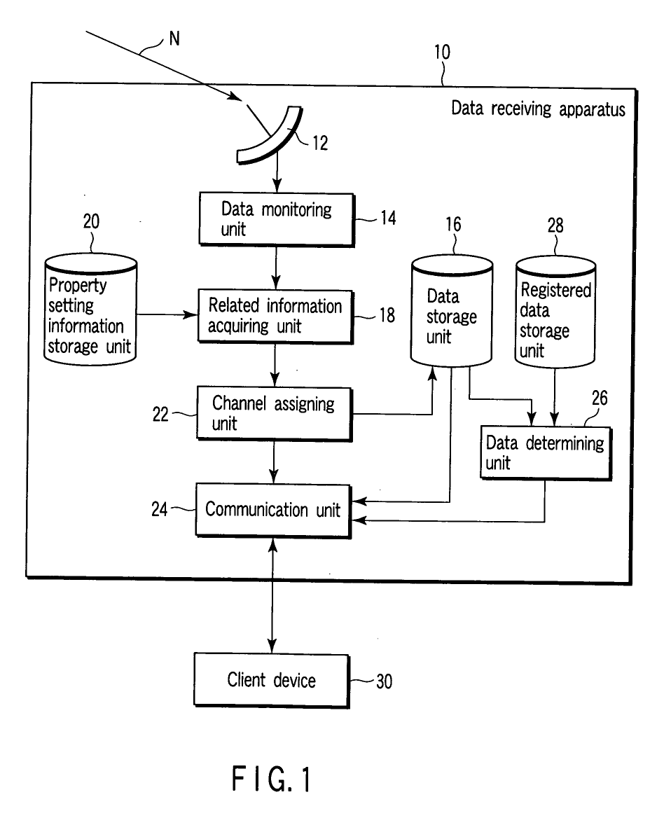

FIG. 1 is a functional block diagram showing an example of a data receiving apparatus to which a data receiving method according to an embodiment of the present invention is applied.

A data receiving apparatus 10 according to this embodiment comprises an antenna 12, data monitoring unit 14, data storage unit 16, related information acquiring unit 18, property setting information storage unit 20, channel assigning unit 22, communication unit 24, data determining unit 26, and registered data storage unit 28.

The antenna 12 receives audiovisual data and non-audiovisual data (both of which are represented by “N”) broadcast from a broadcasting station or the like. These data may be either in digital form or analog form.

The data monitoring unit 14 monitors the data received by the antenna 12, and discriminates whether the monitored data is audiovisual data or non-audiovisual data. Each data broadcast from a broadcasting station or the like contains a data discrimination flag for discriminating between audiovisual data and non-audiovisual data. By setting this data discrimination flag to, for example, “0” to indicate audiovisual data and to “1” to indicate non-audiovisual data, the data monitoring unit 14 discriminates audiovisual data from non-audiovisual data in accordance with the flag value. The data monitoring unit 14 then transfers the discriminated audiovisual data and non-audiovisual data to the related information acquiring unit 18.

The related information acquiring unit 18 discriminates the type of non-audiovisual data transferred from the data monitoring unit 14, acquires information corresponding to a given item set in advance for each type of non-audiovisual data stored in the property setting information storage unit 20 from the non-audiovisual data in accordance with the discriminated type, and generates a related information table.

As described above, data broadcast from a broadcasting station or the like contains a flag for discriminating between audiovisual data and non-audiovisual data. Non-audiovisual data also contains a type discrimination flag for discriminating the type of data. Although not limited to the following, the types of non-audiovisual data include, for example, setting data and application programs for the data receiving apparatus 10 and a client device 30 to which data is distributed from the data receiving apparatus 10, program information data, and data for notification to viewers. As the client device 30, for example, a TV set, a PC with a TV function, a video recorder, or DVD recorder is available. This type discrimination flag is set to, for example, “1”, “2”, “3”, “4”, “5”, and “6” to respectively indicate setting data for the data receiving apparatus 10, an application program for the data receiving apparatus 10, setting data for the client device 30, an application program for the client device 30, program information data, and data for notification to viewers. This allows the related information acquiring unit 18 to discriminate the type of non-audiovisual data from its flag value.

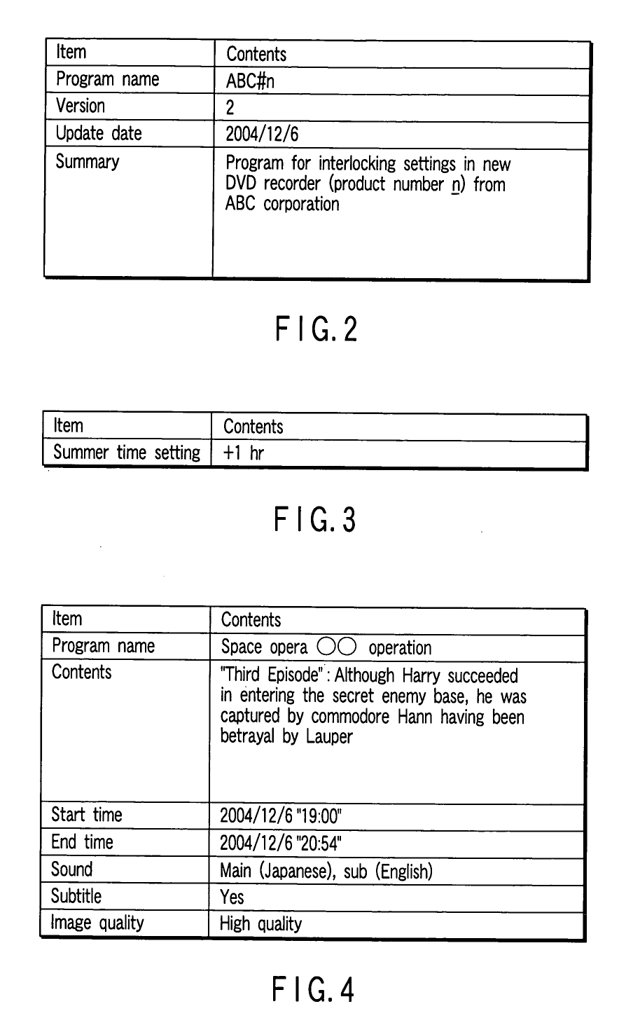

In the property setting information storage unit 20, items required to generate a related information table are stored in correspondence with the types of non-audiovisual data. These items are defined in advance and written in the property setting information storage unit 20 in advance. A related information table is a table generated by acquiring only necessary items indicating the contents of non-audiovisual data from the non-audiovisual data. FIGS. 2 to 4 each show an example of such a table.

FIG. 2 shows an example of a related information table generated for an application program. The items include program name, version, update date, and summary. These items are written in the property setting information storage unit 20 in advance as items for the generation of a related information table for an application program.

FIG. 3 shows an example of a related information table generated for setting data. This table is used to advance the clock by 1 hr in accordance with the summer time. The necessary item is “± time”. This item is also written in the property setting information storage unit 20 in advance as an item for the generation of a related information table for an application program. Note that setting data is not limited to such clock setting, and there are other various setting data. For this reason, type discrimination flags are finely set for setting data, and items are respectively set for the finely set flags and written in the property setting information storage unit 20 in advance. This makes it possible to further discriminate and handle items in accordance with the types of setting data.

FIG. 4 shows an example of a related information table generated for program information data. The items include a program name, contents, start time, end time, sound, subtitle, and image quality. These items are written in the property setting information storage unit 20 in advance as items for the generation of a related information table for program information data.

Upon receiving non-audiovisual data from the data monitoring unit 14, the related information acquiring unit 18 discriminates the type of the data from its type discrimination flag, and acquires items stored in the property setting information storage unit 20 in accordance with the discriminated type. The related information acquiring unit 18 then acquires information corresponding to the items from the non-audiovisual data and generates a related information table like that shown in one of FIGS. 2 to 4.

The related information acquiring unit 18 adds the related information table generated in the above manner to the non-audiovisual data and transfers the resultant data to the channel assigning unit 22. Note that with regard to audiovisual data transferred from the data monitoring unit 14, the related information acquiring unit 18 generates program information by acquiring a title, airtime, performers, and the like from the audiovisual data. The related information acquiring unit 18 then adds the program information generated in this manner to the audiovisual data and transfers the resultant data to the channel assigning unit 22. Note that a related information table may be generated for audiovisual data in the same manner as for non-audiovisual data.

The channel assigning unit 22 individually assigns channel numbers to the audiovisual data and non-audiovisual data transferred from the related information acquiring unit 18. The audiovisual data and non-audiovisual data are then stored in the data storage unit 16 in association with the assigned channel numbers. The data storage unit 16 has its own storage capacity limit. For this reason, if there is a free space in the data storage unit 16, new data is written and stored in the free space. If, however, data are stored up to the maximum storage capacity, new data are sequentially overwritten on old data.

A channel number is an identification number to be used to extract desired data from the data storage unit 16. Therefore, identical channel numbers must not be redundantly registered in the data storage unit 16. If, however, some channel number ceases to be used as old data is overwritten, the channel number may be reused.

When new data is written in the data storage unit 16 with a channel number by the channel assigning unit 22, the communication unit 24 acquires a related information table, if the newly written data is non-audiovisual data, or program information, if the newly written data is audiovisual data, together with the corresponding channel number. The communication unit 24 then notifies the client device 30 of the acquired related information table or program information and the channel number through a communication network 32 such as Ethernet or the Internet.

Displaying the related information table or program information and the channel number notified in this manner on the display screen of the client device 30 allows the user to comprehend the related information table or program information of the newly broadcast data and the channel number through the client device 30. If the user determines from the contents of the related information table or program information that the data is necessary, he/she inputs a channel number corresponding to the data to the client device 30. The communication unit 24 is notified through the communication network 32 of the channel number input in this manner.

The communication unit 24 then acquires data corresponding to the channel number, notified from the client device 30, from the data storage unit 16, and distributes the data to the client device 30 through the communication network 32. With this operation, the client device 30 acquires the audiovisual data or non-audiovisual data. Upon acquiring the audiovisual data, the client device 30 can display it by using the display function of the client device 30, or can record it by using the recording function of the client device 30. Upon acquiring the non-audiovisual data, the client device 30 can download and set a new program, download an updated program and update the program, acquire setting data to change setting information on the basis of the setting data, and display program information data or data for notification.

As described above, the data receiving apparatus 10 according to this embodiment has not only the function of distributing data based on a request from the client device 30 to the client device 30 but also the function of, when predetermined data is written in the data storage unit 16, automatically distributing the data to the client device 30. This automatic distribution function is implemented by the data determining unit 26 and registered data storage unit 28.

When this automatic distributing function is to be used, data to be automatically distributed is determined in advance with respect to the client device 30, and the corresponding definition information is stored in the registered data storage unit 28 in advance. Although a definition method is not limited to this, for example, a method of defining data by designating a data type, genre, or keyword is used.

When data is written in the data storage unit 16 together with a channel number, the data determining unit 26 compares the contents of the data with the definition information stored in the registered data storage unit 28. If this data coincides with the data type, genre, keyword, or the like defined by the definition information, the data determining unit 26 outputs this data to the communication unit 24.

The communication unit 24 then distributes the output data to the client device 30 through the communication network 32. This makes the client device 30 automatically acquire desired audiovisual data or non-audiovisual data. When such data is automatically acquired as well, the data can be displayed by using the display function of the client device 30 or recorded by using the recording function of the client device 30. In addition, when non-audiovisual data is acquired, the client device 30 can download and set a new program, download an updated program and update the program, acquire setting data to change setting information on the basis of the setting data, and display program information data or data for notification.

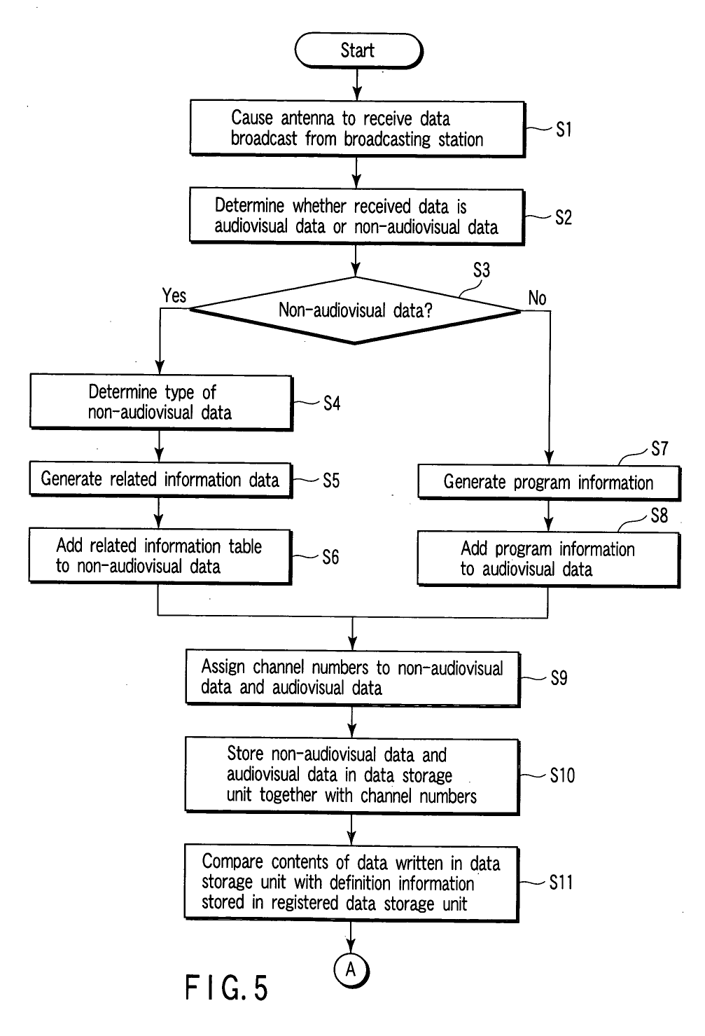

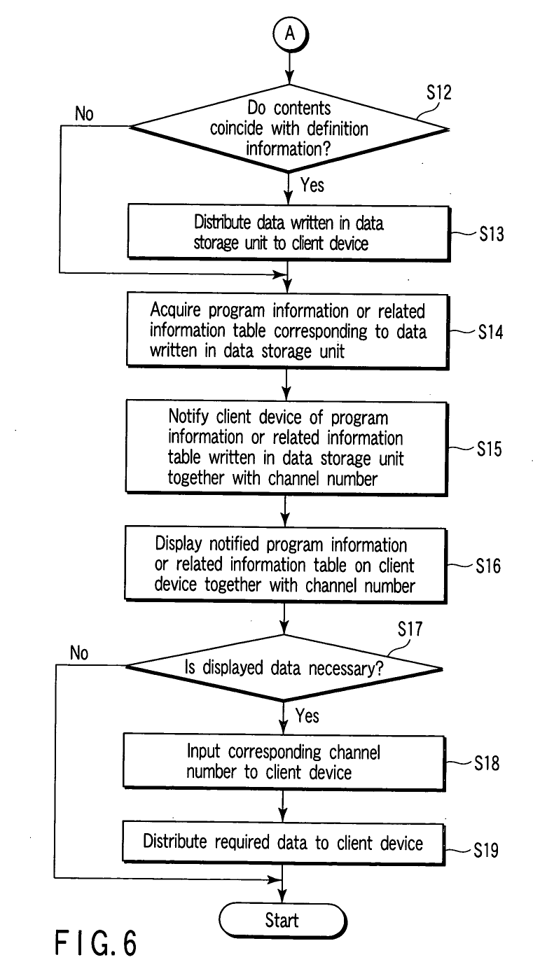

The operation of the data receiving apparatus to which the data receiving method according to this embodiment having the above arrangement is applied will be described next with reference to the flowcharts of FIGS. 5 and 6.

When audiovisual data or non-audiovisual data in a digital form or analog form is broadcast from a broadcasting station or the like, the broadcast data is received by the antenna 12 (S1).

The data monitoring unit 14 monitors the data received by the antenna 12 to discriminate whether the monitored data is audiovisual data or non-audiovisual data (S2). The data broadcast from the broadcasting station or the like contains a data discrimination flag for discriminating between audiovisual data and non-audiovisual data. For example, this flag is set to “0” to indicate audiovisual data, and to “1” to indicate non-audiovisual data. The data monitoring unit 14 discriminates between audiovisual data and non-audiovisual data from this flag value. The discriminated audiovisual data or non-audiovisual data is then transferred to the related information acquiring unit 18.

If the data transferred from the data monitoring unit 14 is non-audiovisual data (YES in step S3), the related information acquiring unit 18 further discriminates the type of the data (S4). On the other hand, items necessary for the generation of a related information table are stored in the property setting information storage unit 20 in accordance with the type of data. When the type is discriminated in step S4, the related information acquiring unit 18 acquires information corresponding to items corresponding to the type from the non-audiovisual data transferred from the data monitoring unit 14, and a related information table is generated (S5). The related information acquiring unit 18 adds the related information table generated in this manner to the non-audiovisual data (S6), and transfers the resultant data to the channel assigning unit 22.

If the data transferred from the data monitoring unit 14 is audiovisual data (NO in step S3), the related information acquiring unit 18 generates program information by acquiring a title, airtime, performers, and the like from the audiovisual data (S7). The related information acquiring unit 18 further adds the program information generated in this manner to the audiovisual data (S8), and then transfers the resultant data to the channel assigning unit 22.

The channel assigning unit 22 individually assigns a channel number to each audiovisual data or non-audiovisual data transferred from the related information acquiring unit 18 (S9). The audiovisual data or non-audiovisual data is written in the data storage unit 16 in association with the assigned channel number (S10). The data storage unit 16 has its own storage capacity limit. For this reason, if there is free space in the data storage unit 16, new data is written and stored in the free space. If, however, data are stored up to the maximum storage capacity, new data are sequentially overwritten on old data. In this case, the channel number of each data written in the data storage unit 16 is a unique number, and there is no possibility that identical channel numbers are redundantly registered.

When data is written in the data storage unit 16 in this manner, the data determining unit 26 compares the contents of the written data with the definition information stored in the registered data storage unit 28 (S11). If this data coincides with the data type, genre, keyword, or the like defined by the definition information (YES in step S12), the data is output to the communication unit 24.

This output data is further distributed from the communication unit 24 to the client device 30 through the communication network 32 (S13). This allows the client device 30 to automatically acquire desired audiovisual data or non-audiovisual data.

Note that the data determining unit 26 and registered data storage unit 28 can be omitted. In this case, the flow skips the processing in steps S11 to S13 and advances to step S14.

In step S14, the communication unit 24 acquires related information table or program information corresponding to the data newly written in the data storage unit 16, together with the corresponding channel number (S14), and notifies the client device 30 of the acquired data through the communication network 32 (S15).

Displaying the related information table or program information and the channel number notified in this manner on the display screen of the client device 30 allows the user to recognize the newly broadcast related information table or program information and channel number through the client device 30 (S16). If the user determines from the contents of the related information table or program information that the data is necessary (YES in step S17), he/she inputs a channel number corresponding to the data to the client device 30 (S18). The communication unit 24 is notified through the communication network 32 of the channel number input in this manner.

The communication unit 24 then acquires data corresponding to the channel number, notified from the client device 30, from the data storage unit 16, and distributes the data to the client device 30 through the communication network 32 (S19).

The client device 30 can acquire desired audiovisual data or non-audiovisual data by designating it.

When audiovisual data is acquired in this manner, the data can be displayed by using the display function of the client device 30 or can be recorded by using the recording function of the client device 30. When non-audiovisual data is acquired, the client device 30 can download and set a new program, download an updated program and update the program, acquire setting data to change setting information on the basis of the setting data, and display program information data or data for notification.

As described above, in the data receiving apparatus to which the data receiving method according to this embodiment is applied, with the above function, when new audiovisual data or non-audiovisual data is broadcast from a broadcasting station or the like, data which coincides with a pre-designated condition can be automatically distributed to the client device 30. When new audiovisual data or non-audiovisual data is broadcast from a broadcasting station, since the client device 30 is notified of the corresponding program information or related information table, the user can know that desired data has been broadcast. If this data is necessary, the user can reliably acquire the data by issuing a distribution request.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A data receiving apparatus comprising:
a receiving unit configured to receive at least one of broadcast audiovisual data and non-audiovisual data;
a detecting unit configured to detect the non-audiovisual data received by the receiving unit;
an acquiring unit configured to acquire information corresponding to a predetermined item from the non-audiovisual data detected by the detecting unit in accordance with a type of the data;
an assigning unit configured to assign an identification number to the non-audiovisual data from which the information is acquired by the acquiring unit; and
a notifying unit configured to notify a client device for viewing of the audiovisual data of the identification number assigned by the assigning unit and the information acquired by the acquiring unit from the non-audiovisual data assigned the identification number.

2. An apparatus according to claim 1, further comprising a distributing unit configured to distribute non-audiovisual data corresponding to the notified identification number to the client device when the identification number is notified and a distribution request for the non-audiovisual data is issued from the client device.

3. An apparatus according to claim 1, wherein non-audiovisual data to be distributed to the client device is predetermined, the apparatus further comprising:
a determining unit configured to determine whether or not non-audiovisual data detected by the detecting unit is included in the predetermined non-audiovisual data; and
a distributing unit configured to distribute the non-audiovisual data detected by the detecting unit to the client device when the determining unit determines that the non-audiovisual data detected by the detecting unit is included in the predetermined non-audiovisual data.

4. An apparatus according to claim 3, wherein the non-audiovisual data is a program or data which is used in the client device.

5. An apparatus according to claim 2, wherein the non-audiovisual data is a program or data which is used in the client device.

6. An apparatus according to claim 1, wherein the non-audiovisual data is a program or data which is used in the client device.

7. A data receiving method comprising:
receiving at least one of broadcast audiovisual data and non-audiovisual data;
detecting the received non-audiovisual data;
acquiring information corresponding to a predetermined item from the detected non-audiovisual data in accordance with a type of the data;
assigning an identification number to the non-audiovisual data from which the information is acquired; and
notifying a client device for viewing of the audiovisual data of the assigned identification number and the information acquired from the non-audiovisual data assigned the identification number.

8. A method according to claim 7, further comprising distributing non-audiovisual data corresponding to the notified identification number to the client device when the identification number is notified and a distribution request for the non-audiovisual data is issued from the client device.

9. A method according to claim 7, further comprising:
predetermining non-audiovisual data to be distributed to the client device;
determining whether or not the detected non-audiovisual data is included in the predetermined non-audiovisual data; and
distributing the detected non-audiovisual data to the client device when it is determined that the detected non-audiovisual data is included in the predetermined non-audiovisual data.

10. A method according to claim 9, wherein the non-audiovisual data is a program or data which is used in the client device.

11. A method according to claim 8, wherein the non-audiovisual data is a program or data which is used in the client device.

12. A method according to claim 7, wherein the non-audiovisual data is a program or data which is used in the client device.
